(19) United States
(12) Patent Application Publication
(10) Pub. No.: US 2006/0081604 A1
(43) Pub. Date: Apr. 20, 2006

(54) Actuation device for a cooking appliance

(76) Inventor: Uwe Has, Unterneukirchen-Oberschroffen (DE)

Correspondence Address: JOHN T. WINBURN, 100 BOSCH BOULEVARD, NEW BERN, NC, 28562, US

(21) Appl. No.: 10/531,788

(22) PCT Filed: Oct. 15, 2003
(86) PCT No.: PCT/EP03/11444

§ 371 Date: Apr. 18, 2005

(30) Foreign Application Priority Data
Oct. 21, 2002 (DE) 102 48 993.9

(51) Int. Cl. B23K 10/00; H05B 1/02

(52) U.S. Cl. 219/491

(57) ABSTRACT

An actuation device for a cooking appliance having at least two cooking points. The actuation device includes at least one actuation element and an associated sensor unit. The sensor unit senses a plurality of different actuation modes of the actuation element, such as selecting and activation and deactivation of one of the cooking points, adjustment of a heating step and additional activation modes in addition to the cooking point actuation modes.

The invention relates to an actuation device for a cooking appliance according to the preamble of claim 1.

A generic actuation device for a cooking appliance with four cooking points is known from EP 0 962 707 A2. The actuation device comprises an actuation element with an associated sensor unit which can sense the actuation modes of the actuation element for selecting the cooking points and for adjusting a heating step of the respectively selected cooking point. For selecting one of the cooking points the actuation element, which is constructed as a tilting toggle, is tilted from its initial position into a selection position in the direction of the cooking point to be selected. The actuation element is turned into a selection position to adjust and activate a heating step of the selected cooking point. After releasing the actuation element, this is restored into its initial position by a restoring force. The actuation element is turned anticlockwise into its initial position to deactivate the selected and activated cooking point.

The object of the invention is especially to provide a generic actuation device to achieve more comfortable operation of a cooking appliance. The object is solved according to the invention by the features of claim 1 whilst advantageous embodiments and further developments of the invention can be deduced from the dependent claims.

The invention relates to an actuation device for a cooking appliance comprising at least two cooking points, which has at least one actuation element with an associated sensor unit which senses the actuation modes of the actuation element for selection of the cooking points, for adjustment of a heating step and activation of the respectively selected cooking point and for deactivation of the selected and activated cooking point.

It is proposed that the sensor unit can sense at least one further actuation mode of the actuation element in addition to the actuation modes for selecting the cooking points, for adjusting a heating step and activating the respectively selected cooking point and for deactivating the selected and activated cooking point. Further functions can clearly advantageously be integrated in the actuation element, embracing and actuating a further actuation element can be at least largely avoided, operating comfort can be enhanced and additional components, such as especially actuation elements, can be dispensed with. For example, a general functional readiness of the cooking appliance and/or a parboiling surge of a selected and activated cooking point can be triggered, an automatic cooking system and/or cooking sensor system can be activated and/or a further heating element can be switched on/or switched off via the further actuation mode of the actuation element.

Basically, all further actuation modes which seem logical to the person skilled in the art are feasible. However, if the sensor unit can sense an actuation of the actuation element, starting from an initial position in at least one, preferably in a plurality of actuation directions in addition to the cooking points, further actuation modes which can be sensed can be achieved with a particularly simple design and inexpensively, with few or possibly even without additional components, for already pre-defined actuation modes and especially for actuations in the direction of actuation of the cooking points to select the respective cooking point. Further, an easy-to-understand functional allocation of the actuation modes can be achieved. A necessary sensor element for sensing the further actuation mode of the sensor unit can be executed integrally with one or more other sensor elements or can advantageously be executed in the same fashion as other sensor elements.

If the sensor unit can sense an actuation of the actuation element in a direction of actuation pointing in front of the cooking appliance, an advantageously clear delimitation for already existing actuation modes can be achieved. Furthermore, in addition to an easy-to-understand functional allocation, an advantageously clear delimitation for already existing actuation modes can be achieved by integrating a push button in the actuation element. The push button can be formed by an additional component integrated in the actuation element, such as for example, by a push-button integrated in a gripping surface or advantageously on a front side of the actuation element or it can be executed at least largely integrally with the actuation element itself, for example, by the actuation element serving as a push button itself and the push actuation of the actuation element being sensed by a sensor element.

In a further embodiment of the invention, it is proposed that the actuation element is formed by a toggle having a diameter between 0.8 cm and 1.2 cm in its gripping area whereby comfortable actuation of the actuation element can be achieved.

It is further proposed that the actuation device comprises a mechanism which can change the extension of the actuation element over a cooking surface of the cooking point so that a large comfortable extension is achieved during actuation of the actuation element and after actuation of the actuation element the extension is at least largely reduced and any hindrance of further cooking operation can be reliably avoided. The actuation element can be at least partly or advantageously completely collapsible by means of the mechanism and/or it can be executed such that its extension can be varied in a telescopic fashion.

In order to avoid a user being hindered by the actuation element as far as possible when cooking on the cooking appliance and to reduce the risk of damage to the actuation element, for example, by a cooking pot, in the mounted state the actuation element of the actuation device extends, at least in one operating position, preferably less than 2.5 cm over the cooking surface of the cooking points. An advantageous free space, especially for fingers of a user, can thereby be achieved between gripping elements of pans and saucepans and the actuation element.

The actuation element can be constructed in various ways, for example, this can be formed by a toggle mounted such that it can be translationally displaced and/or tilted, which passes through a plate, especially a glass ceramic plate, of the cooking appliance or is mounted on a plane, concave or convex surface of the plate. When mounting the toggle on a convex or concave surface, an advantageous centring of the toggle can be achieved. Alternatively to a toggle, the actuation element could also be formed by a ball mounted rotatably in a recess or by a contact area. In actuation elements of this type, especially further actuation modes can be integrated particularly simply and an overall particularly comfortable actuation of the actuation element can be achieved. For example, switching to and fro between different functional levels could be achieved by touching and/or pressing the actuation element once or several times. Contact area should especially be understood in this connection as areas which can sense a travel path of an object, especially a finger of a user, as is known especially in portable computers to control a display arrow on a screen.

Further, all types of scanning by the sensor unit which seem suitable to the person skilled in the art, are also basically feasible, such as in particular mechanical, thermal, electrical, magnetic and/or optical scanning with contract-free scanning basically to be preferred to contact scanning.

Further advantages are obtained from the following description of the drawings. The drawings show exemplary embodiments of the invention. The drawings, the description and the claims contain numerous features in combination. The person skilled in the art will appropriately consider the features individually and combine them to give logical further combinations.

In the figures:

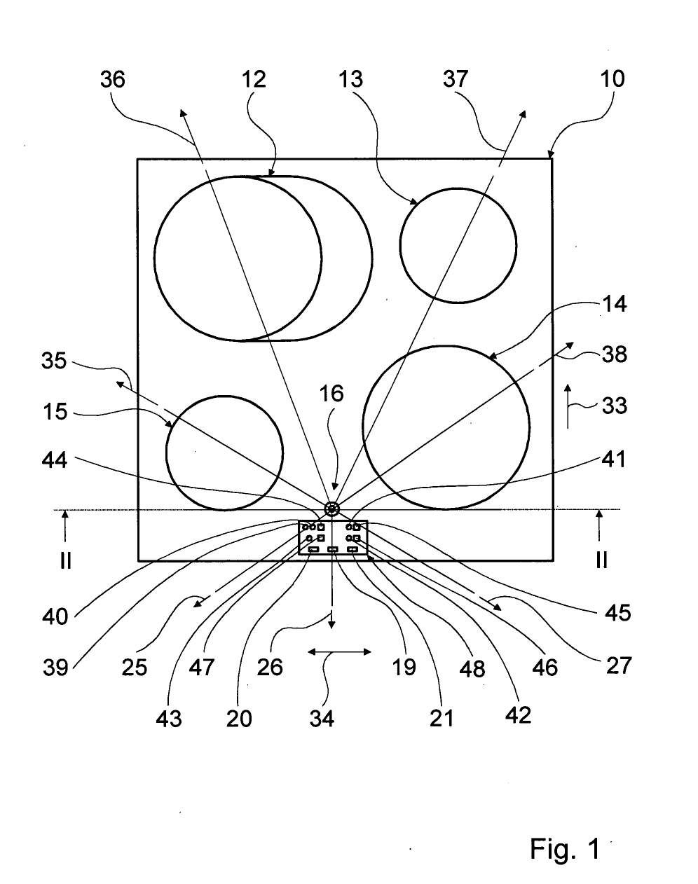

FIG. 1 is a cooking appliance with an actuation device according to the invention in a plan view,

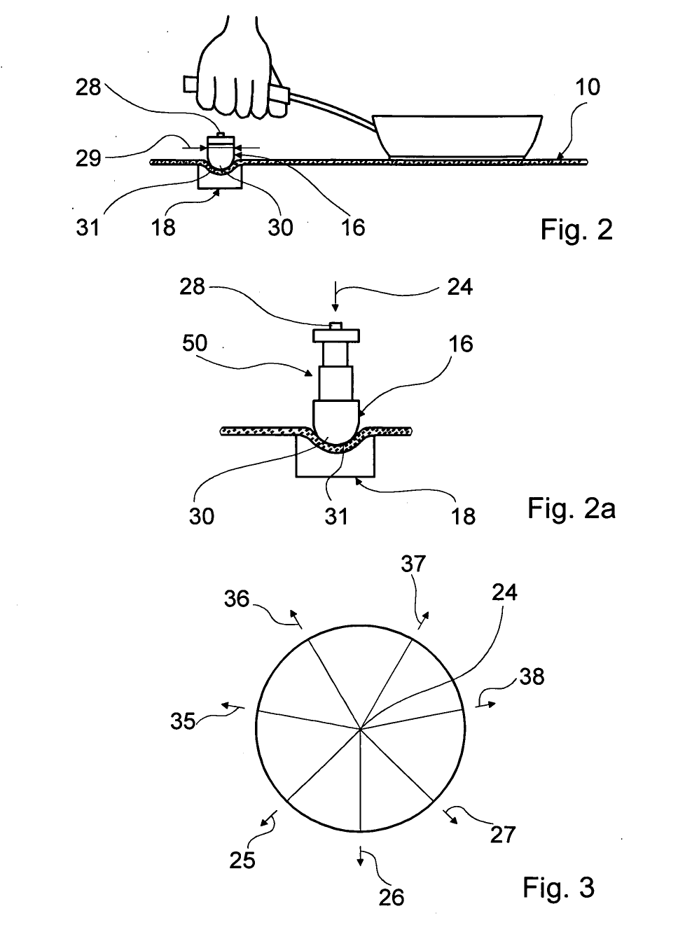

FIG. 2 is a schematic section along the line II-II in FIG. 1,

FIG. 2a is a section from FIG. 2 with the actuation element extended,

FIG. 3 is a function pattern of an actuation element of the actuation device from FIG. 1,

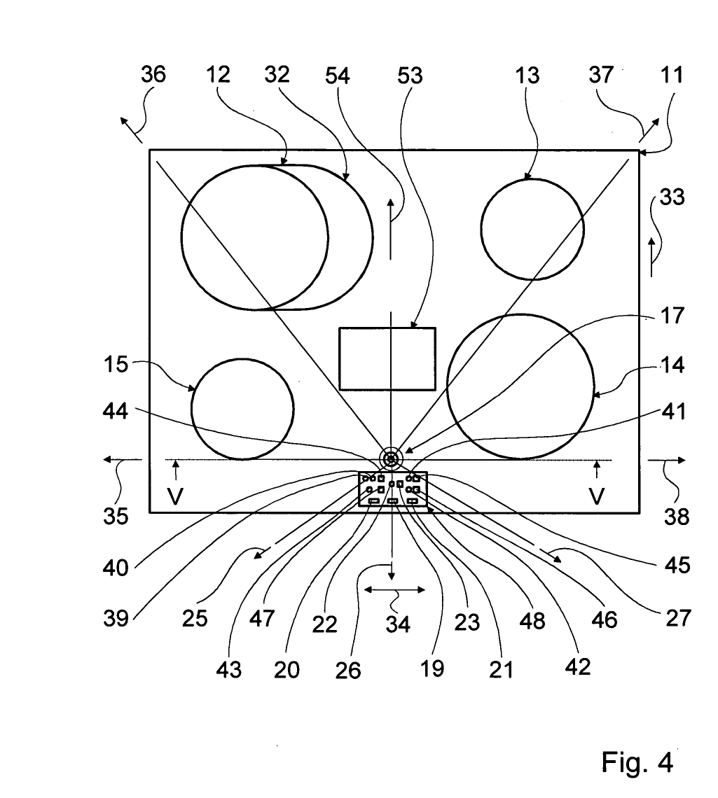

FIG. 4 is an alternative cooking appliance to FIG. 1 with a warming point and an alternative actuation device in plan view,

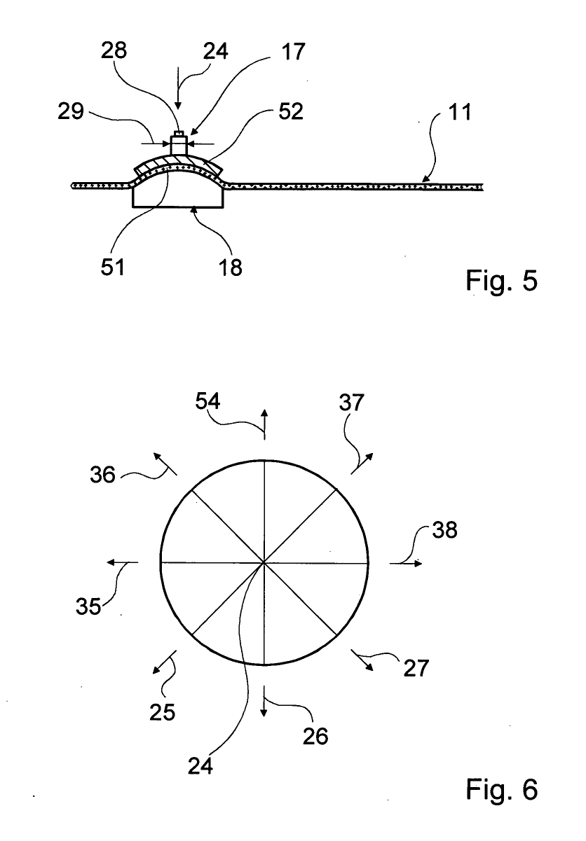

FIG. 5 is a schematic section along the line V-V in FIG. 4 and

FIG. 6 is a function pattern of an actuation element of the actuation device from FIG. 4.

FIG. 1 shows a substantially square cooking appliance 10 with four cooking points 12, 13, 14, 15 and an actuation device according to the invention. The actuation device comprises an actuation element 16 constructed as a tilting toggle and a sensor unit 18 associated with the actuation element 16 (FIGS. 1 and 2).

The actuation element 16 is arranged in the depth 33 of the cooking appliance 10 in the front area of the same on an imaginary line through two ends of the front cooking points 14, 15 facing the user and is centrally arranged in the width 34 of the cooking appliance 10. A hemispherical bearing head 30 is moulded onto the actuation element 16 at its lower end, which supports the actuation element 16 in a hemispherical recess 31 in a glass ceramic plate of the cooking appliance 10. The bearing head 30 lies in the recess 31 on the glass ceramic plate of the cooking appliance 10 but could also be mounted at least largely contact-free in the recess 31 by means of a magnetic field.

When the actuation element is actuated, optical input quantities can be sensed by the optical sensor unit 18 arranged in the area of the recess 31 underneath the glass ceramic plate of the cooking appliance 10 and specifically actuation modes of the actuation element 16 to select the cooking points 12, 13, 14, 15, to adjust a heating step and activate the respectively selected cooking point 12, 13, 14 or 15 and to deactivate the selected and activated cooking point 12, 13, 14, 15 can be sensed by the sensor unit 18.

For selecting one of the cooking points 12, 13, 14, or 15 the actuation element 16 is tilted from an initial position 23 in the direction of actuation 35, 36, 37 or 38 to the respective cooking point 12, 13, 14 or 15. The actuation element 16 comprises a telescopic mechanism 50 and can be actuated in the retracted state or it can be withdrawn in a telescopic fashion for actuation to about a hand width, i.e. to about 9 cm (see FIG. 2a). The actuation element 16 has a diameter 29 of about 1.0 cm in its gripping area and extends about 2.0 cm over the cooking surfaces of the cooking points 12, 13, 14, 15 in the retracted state.

In order to avoid the actuation element 16 becoming detached during withdrawal from the recess 31 of the glass ceramic plate, this is secured in the recess 31 by a mechanism not shown in detail which also restores the actuation element 16 into its initial position 24 after release. Instead of or in addition to the mechanism, the actuation element 16 can also be secured in the recess 31 by magnetic forces and can be loaded in the direction of its initial position 24.

When a tilt end position or a selection position is reached, the respective cooking point 12, 13, 14 or 15 is selected which is indicated to the user by one of the luminous elements 39, 40, 41, 42, 43 associated with the respective cooking point 12, 13, 14 or 15 lighting up in an indicating device 48 arranged in front of the actuation element 16. In order to avoid the indicating device 48 being covered during actuation, this can be arranged by the user in the direction of the cooking points 12, 13, 14, 15 after the actuation element 16.

The actuation element 16 is turned about its longitudinal axis to adjust a desired heating step and activate the respectively selected cooking point 12, 13, 14 or 15. The adjusted heating step is indicated by a seven-segment indicating element 44, 45, 46 or 47 associated with the cooking point 12, 13, 14 or 15. For deactivating the selected and activated cooking point 12, 13, 14 or 15 the heating step is set to zero via the actuation element 16 in the respective tilt end position. It is basically also feasible that a certain heating step is adjusted automatically when selecting the cooking point 12, 13, 14 or 15. According to the invention, further actuation modes of the actuation element 16 can be sensed by the sensor unit 18 in addition to the actuation modes for selecting the cooking points 12, 13, 14, 15, for adjusting a heating step and activating the respectively selected cooking point 12, 13, 14 or 15 and for deactivating the selected and activated cooking point 12, 13, 14 or 15.

The sensor unit 18 can sense actuations of the actuation element 16, starting from the initial position 24 in three directions of actuation 25, 26, 27 in addition to the cooking points 12, 13, 14, 15 and specifically in the directions of actuation 25, 26, 27 pointing in front of the cooking appliance 10. By actuating or tilting the actuation element 16, starting from the initial position 24 in the direction of actuation 26 running perpendicular to a front side of the cooking appliance 10, a basic functional readiness of the cooking appliance 10 can be activated and deactivated and specifically, when the functional readiness is deactivated, the same can be activated by actuating the actuation element 16 in the direction of actuation 26 and when the functional readiness is activated, the same can be deactivated by actuating the actuation element 16 in the direction of actuation 26. The function of a main switch is thus integrated in the actuation element 16 via which all the cooking points 12, 13, 14, 15 can be switched off at once. When the basic functional readiness of the cooking appliance 10 is activated, this is indicated to the user by a luminous element 19 lighting up in the indicating device 48.

By actuating or tilting the actuating element 16, starting from the initial position 24 in the direction of actuation 25, an automated cooking system can be activated and deactivated for the selected cooking point 12, 13, 14 or 15 so that heating steps are adjusted at least partly automatically. By actuating or tilting the actuating element 16, starting from the initial position 24 in the direction of actuation 27, a cooking sensor not shown in detail can be activated and deactivated. When the automated cooking system or the cooking sensor is activated, this is indicated to the user by a luminous element 20 or 21 lighting up.

An angular distance of about 50° is located between the directions of actuation 35, 36 and between the directions of actuation 37, 38, an angular distance of about 60° is located between the directions of actuation 36, 37, an angular distance of about 55° is located between the directions of actuation 25, 35 and between the directions of actuation 27, 38 and an angular distance of about 45° is located between the directions of actuation 25, 26 and between the directions of actuation 26, 27 (see FIG. 3). Instead of the angular distances shown in the exemplary embodiment, other angular distances between the directions of actuation 25, 26, 27, 35, 36, 37 and 38 which seem logical to the person skilled in the art, are also feasible, in particular the directions of actuation 35, 36, 37, 38 could advantageously be arranged uniformly distributed over 180° in order to achieve large distances between these directions of actuation 35, 36, 37, 38. Further, all the directions of actuation 25, 26, 27, 35, 36, 37, 38 could be arranged uniformly distributed over 360° in order to achieve the greatest possible angular distance between all the directions of actuation 25, 26, 27, 35, 36, 37, 38.

In an angular range of ±10° in each case about the directions of actuation 25, 26, 27, 35, 36, 37, 38, a tilting of the actuation element 16 is registered by the sensor unit 18 and interpreted as being in the respective direction of actuation 25, 26, 27, 35, 36, 37 or 38, whereby guidance of the actuation element 16 can basically be dispensed with. In order to avoid undesired tilting of the actuation element 16 during turning of the actuation element 16, however, the actuation element 16 can also be constructed as guided, for example, via a link.

Further, a pushbutton 28 constructed as a press button is integrated in the actuation element 16 on its front side. When the actuation element 16 is tilted to select a cooking point 12, 13, 14 or 15 in the direction of actuation 35, 36, 37 or 38 of the same, after adjusting a heating step and activating the respectively selected cooking point 12, 13, 14 or 15, a parboiling surge can be triggered and deactivated again by actuating the pushbutton 28. When the cooking point 12 is selected, a second heating element or a second heating circuit 32 can additionally be switched on or off by actuating the pushbutton 28 twice in quick succession. FIGS. 4 to 6 show an alternative exemplary embodiment. In the exemplary embodiments substantially the same components in the description are denoted by the same reference numbers. Furthermore, reference can be made to the description relating the exemplary embodiment in FIGS. 1 to 3 with regard to the features and functions which remain the same. The following description is substantially limited to the differences from the exemplary embodiment in FIGS. 1 to 3.

FIG. 4 shows a rectangular cooking appliance 11 having a glass ceramic plate with a cup-shaped elevation 51 on which an actuation element 17 formed by a toggle with a bearing box 52 is tiltably mounted (FIGS. 4 and 5). In addition to four cooking points 12, 13, 14, 15, the cooking appliance 11 also has a warming point 53 between the same, for example for warming plates etc. The warming point 53 can be selected by actuating or tilting the actuation element 17, starting from its initial position 24, in the direction of actuation 54 towards the warming point 53 and can be activated and deactivated by turning the actuation element 17 in its corresponding tilt end position.

The selection, activation and deactivation of the cooking points 12, 13, 14, 15 and the triggering of a parboiling surge, the activation and deactivation of an automated cooking system, a basic functional readiness and a cooking sensor take place basically as in the exemplary embodiment in FIGS. 1 to 3. A difference from the exemplary embodiment in FIGS. 1 to 3 substantially only consists in the angular distances between directions of actuation 25, 26, 27, 35, 36, 37, 38, 54 for selecting the individual functions wherein the directions of actuation 25, 26, 27, 35, 36, 37, 38 are assigned the same functions as in the exemplary embodiment in FIGS. 1 to 3. An angular distance of about 45° (FIG. 6) is located between the directions of actuation 25, 26, 27, 35, 36, 37, 38, 54. In addition to the luminous elements 19, 20, 21, 39, 40, 41, 42, 43 and seven-segment indicating elements 44, 45, 46, 47, a luminous element 22 and a seven-segment indicating element 23 for the warming point 53 are additionally provided in the indicating device 48 of the actuation device in FIGS. 4 to 6.

### REFERENCE LIST

10 Cooking appliance
11 Cooking appliance
12 Cooking point
13 Cooking point
14 Cooking point
15 Cooking point
16 Actuation element
17 Actuation element
18 Sensor unit
19 Luminous element
20 Luminous element
21 Luminous element
22 Luminous element
23 Seven-segment indicating element
24 Initial position
25 Direction of actuation
26 Direction of actuation
27 Direction of actuation
28 Pushbutton
29 Diameter
30 Bearing head
31 Recess
32 Heating circuit
33 Depth
34 Width
35 Direction of actuation
36 Direction of actuation
37 Direction of actuation
38 Direction of actuation
39 Luminous element
40 Luminous element
41 Luminous element
42 Luminous element
43 Luminous element
44 Seven-segment indicating element
45 Seven-segment indicating element
46 Seven-segment indicating element
47 Seven-segment indicating element
48 Indicating device
50 Mechanism
51 Elevation
52 Bearing box
53 Warming point
54 Direction of actuation

1-8. (canceled)

9. An actuation device for a cooking appliance, comprising:
at least two cooking points;
at least one actuation element having a plurality of actuation modes at least for selection of said cooking points, for adjustment of a heating step, for activation and deactivation of said selected cooking point and at least one additional actuation mode; and
a sensor unit associated with said actuation element for sensing said plurality of actuation modes and said additional actuation mode of said actuation element.

10. The actuation device according to claim 9, including said actuation element being moved in a predetermined direction to actuate said additional actuation mode and said sensor unit sensing said additional actuation mode.

11. The actuation device according to claim 10, including said sensor unit sensing said actuation element being moved in a direction toward the front of the cooking appliance.

12. The actuation device according to claim 9, including said actuation element having a pushbutton incorporated therein for actuating an additional mode.

13. The actuation device according to claim 9, including said actuation element formed by a toggle switch having a gripping area with a diameter substantially in the range of between 0.8 centimeters and 1.2 centimeters.

14. The actuation device according to claim 9, including said actuation element having a telescopic section incorporated therein.

15. The actuation device according to claim 9, including said actuation element mounted on a cooking surface of the cooking appliance and said actuation element extends less than about two and one-half (2.5) centimeters over said cooking surface in at least one actuation mode.

16. A cooking appliance, comprising:
at least two cooking points;
an actuation device for actuating at least said cooking points;
said actuation device including at least one actuation element having a plurality of actuation modes at least for selection of said cooking points, for adjustment of a heating step, for activation and deactivation of said selected cooking point and at least one additional actuation mode; and
a sensor unit associated with said actuation element for sensing said plurality of actuation modes and said additional actuation mode of said actuation element.

17. The cooking appliance according to claim 16, including said actuation element mounted on a cooking surface of the cooking appliance and said actuation element extends less than about two and one-half (2.5) centimeters over said cooking surface in at least one actuation mode.

18. The cooking appliance according to claim 16, including said actuation element being moved in a predetermined direction to actuate said additional actuation mode and said sensor unit sensing said additional actuation mode.

19. The cooking appliance according to claim 18, including said sensor unit sensing said actuation element being moved in a direction toward the front of the cooking appliance.

20. The cooking appliance according to claim 16, including said actuation element having a pushbutton incorporated therein for actuating an additional mode.

21. The cooking appliance according to claim 16, including said actuation element formed by a toggle switch having a gripping area with a diameter substantially in the range of between 0.8 centimeters and 1.2 centimeters.

22. The cooking appliance according to claim 16, including said actuation element having a telescopic section incorporated therein.
